(19) United States
(12) Patent Application Publication
(10) Pub. No.: US 2018/0154698 A1
(43) Pub. Date: Jun. 7, 2018

(54) PNEUMATIC TIRE

(71) Applicant: TOYO TIRE & RUBBER CO., LTD., Itami-shi (JP)

(72) Inventor: Souichi Takahashi, Itami-shi (JP)

(73) Assignee: TOYO TIRE & RUBBER CO., LTD., Itami-shi (JP)

(21) Appl. No.: 15/810,651

(22) Filed: Nov. 13, 2017

(30) Foreign Application Priority Data
Dec. 7, 2016 (JP) 2016-237542

(51) Int. Cl. B60C 11/03; B60C 11/12

(52) U.S. Cl. CPC B60C 11/0306; B60C 2011/0358; B60C 11/1204

(57) ABSTRACT

A pneumatic tire includes a tread portion having a plurality of grooves which extend along a tire peripheral direction, and a plurality of land portions which are comparted in the plurality of peripheral grooves, at least one the land portion includes at least one first land groove which extends so as to have one bent portion formed into a convex shape toward one side in the tire peripheral direction, and at least one second land groove which extends so as to have one bent portion formed into a convex shape toward the other side in the tire peripheral direction.

### CROSS REFERENCE TO RELATED APPLICATIONS

This application claims the benefit of priority of Japanese application no. 2016-237542, filed on Dec. 7, 2016, which is incorporated herein by reference.

### BACKGROUND OF THE INVENTION

### Field of the Invention

The present invention relates to a pneumatic tire having a plurality land portions which are comparted into a plurality of peripheral grooves.

### Description of the Related Art

Conventionally, as a pneumatic tire, there has been known a pneumatic tire having a plurality of land portions which are comparted into a plurality of peripheral grooves extending along a tire peripheral direction. Further, since the land portion is provided with a lot of land grooves which extend so as to have bent portions, an ice steering stability performance of the tire is excellent (for example, Japanese Patent Nos. 5665844 and 5899287).

In the meantime, in each of the land portions of the pneumatic tires according to Japanese Patent Nos. 5665844 and 5899287, the bent portion of the land groove is formed into a convex shape which is directed to the same direction in a tire peripheral direction. Therefore, since rigidity of the land portion becomes small in relation to the force in a specific direction, deformation of the land portion is enlarged. As a result, since a dry turning performance of the tire is particularly deteriorated, it is hard to use the pneumatic tire mentioned above for all seasons.

### SUMMARY OF THE INVENTION

Consequently, an object of the present invention is to provide a pneumatic tire which can improve the dry turning performance while maintaining a snow steering stability performance.

There is provided a pneumatic tire, which includes:

a tread portion having a plurality of grooves which extend along a tire peripheral direction, and a plurality of land portions which are comparted in the plurality of peripheral grooves,

wherein at least one the land portion includes:

at least one first land groove which extends so as to have one bent portion formed into a convex shape toward one side in the tire peripheral direction; and

at least one second land groove which extends so as to have one bent portion formed into a convex shape toward the other side in the tire peripheral direction.

Further, the pneumatic tire may have a configuration in which:

the bent portion of the first land groove is arranged in a first end area in one side of the land portion in a tire width direction,

wherein end portion in the one side of the first land groove in the tire width direction is connected to the peripheral grooves, and

wherein end portion in the other side of the first land groove in the tire width direction is away from the peripheral groove and is arranged in a second end area in the other side of the land portion in the tire width direction.

Further, the pneumatic tire may have a configuration in which:

the bent portion of the second land groove is arranged in the second end area,

wherein end portion in the other side of the second land groove in the tire width direction is connected to the peripheral grooves, and

wherein end portion in the one side of the second land groove in the tire width direction is away from the peripheral groove and is arranged in the first end area,

Further, the pneumatic tire may have a configuration in which:

end portion in one side of the first land groove in a tire width direction is connected to the peripheral grooves, and end portion in the other side of the first land groove in the tire width direction is away from the peripheral groove,

wherein end portion in the other side of the second land groove in the tire width direction is connected to the peripheral grooves, and end portion in the one side of the second land groove in the tire width direction is away from the peripheral groove, and

a portion of the first land groove is superposed on a portion of the second groove in the tire peripheral direction.

Further, the pneumatic tire may have a configuration in which:

the bent portion of the first land groove is arranged in a first end area in the one side of the land portion in the tire width direction, and

wherein the bent portion of the second land groove is arranged in a second end area in the other side of the land portion in the tire width direction.

Further, the pneumatic tire may have a configuration in which:

the bent portion of the first land groove is arranged in a first end area in one side of the land portion in a tire width direction,

wherein end portion in the one side of the first land groove in the tire width direction is connected to the peripheral grooves,

wherein end portion in the other side of the first land groove in the tire width direction is away from the peripheral groove, and

wherein angles at which the one side of the bent portion of the first land groove intersects the tire width direction is smaller than angle at which the other side of the bent portion of the first land groove intersects the tire width direction.

Further, the pneumatic tire may have a configuration in which:

the bent portion of the second land groove is arranged in a second end area in the other side of the land portion in the tire width direction,

wherein end portion in the other side of the second land groove in the tire width direction is connected to the peripheral grooves.

wherein end portion in the one side of the second land groove in the tire width direction is away from the peripheral groove, and

wherein angles at which the other side of the bent portion of the second land groove intersects the tire width direction is smaller than angle at which the one side of the bent portion of the second land groove intersects the tire width direction.

Further, the pneumatic tire may have a configuration in which:

the bent portion of the first land groove is arranged in center portion of the first end area.

Further, the pneumatic tire may have a configuration in which:

the bent portion of the second land groove is arranged in center portion of the second end area.

Further, the pneumatic tire may have a configuration in which:

at least one of the land grooves where the first land grooves are adjacent in the tire peripheral direction is the second land groove, and

wherein at least one of the land grooves where the second land grooves are adjacent in the tire peripheral direction is the first land groove.

As mentioned above, the pneumatic tire achieves an excellent effect that the pneumatic tire can improve the dry turning performance while maintaining a snow steering stability performance.

### BRIEF DESCRIPTION OF DRAWINGS

FIG. 1 is an expansion plan view of a substantial part of a tread surface in a pneumatic tire according to an embodiment;

FIG. 2 is an enlarged view of an area II in FIG. 1;

FIG. 3 is an enlarged expansion plan view of a substantial part of a tread surface in a pneumatic tire according to the other embodiment;

FIG. 4 is an enlarged expansion plan view of a substantial part of a tread surface in a pneumatic tire according to a comparative example; and

FIG. 5 is Table for evaluating examples and the comparative example.

### DETAILED DESCRIPTION OF THE INVENTION

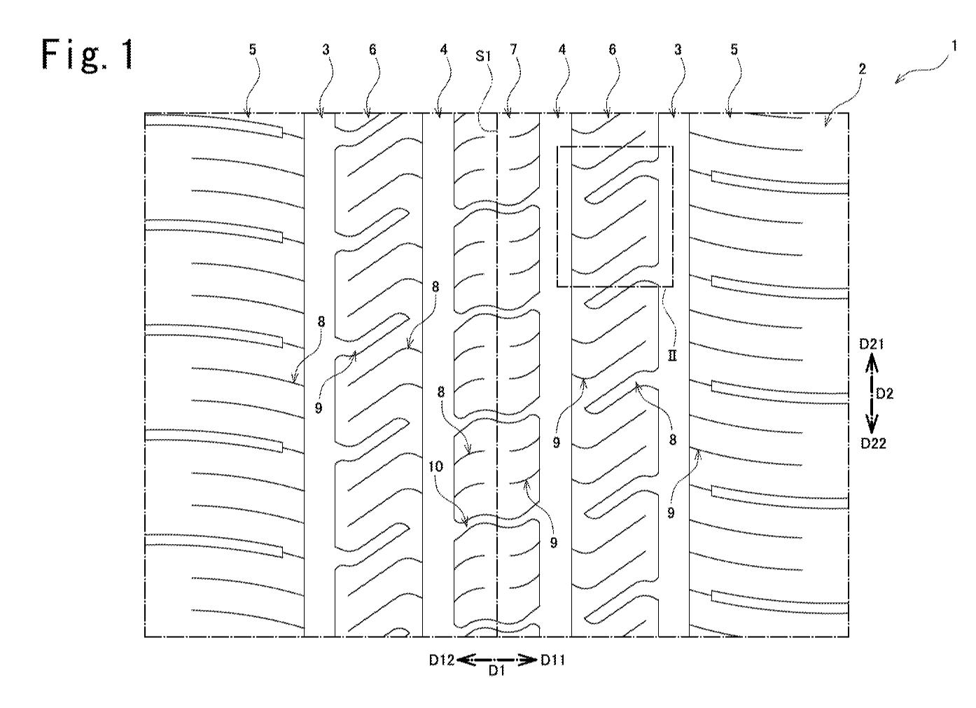

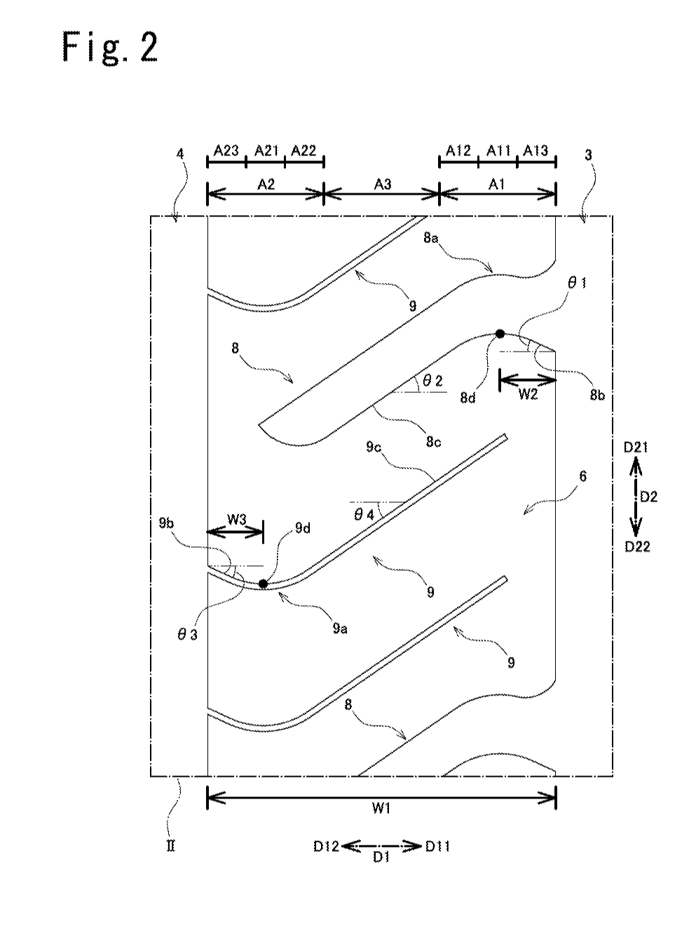

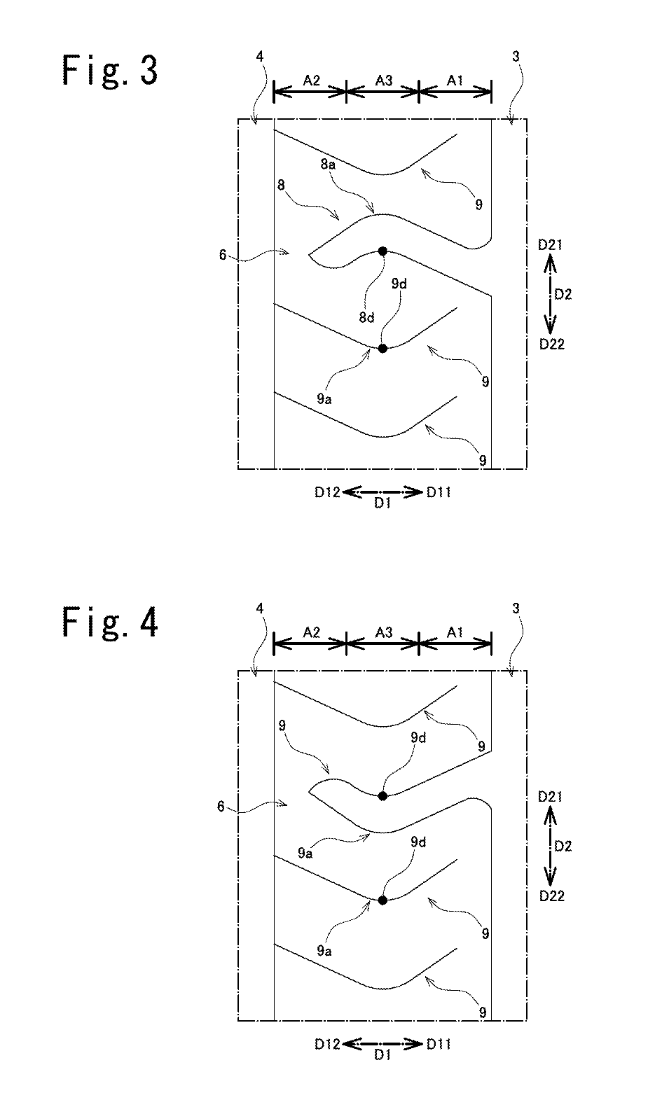

A description will be given below of an embodiment in a pneumatic tire with reference to FIGS. 1 and 2. In each of the drawings (same applies to FIGS. 3 and 4), dimensional ratios of the drawing do not necessarily coincide with actual dimensional ratios, and the dimensional ratios do not necessarily coincide between the drawings.

In FIG. 1 (same applies to the subsequent drawings), a first direction D1 corresponds to a tire width direction D1 which is parallel to a tire rotation axis, and a second direction D2 corresponds to a tire peripheral direction B2 which is a direction around the tire rotation axis. One direction (a rightward direction in FIG. 1) in the tire width direction D1 is called as a first width direction D11 and the other direction (a leftward direction in FIG. 1) is called as a second width direction D12. Further, one direction (an upward direction in FIG. 1) in the tire peripheral direction D2 is called as a first peripheral direction D21, and the other direction (a downward direction in FIG. 1) is called as a second peripheral direction D22.

Further, a tire radial direction corresponds to a diametrical direction of a pneumatic tire (hereinafter, also refer simply to as “tire”). Further, a tire equator surface 1 is a surface which is orthogonal to a tire rotation axis, and is also a surface which is positioned at the center in the tire width direction D1, and a tire meridian surface is a surface which includes the tire rotation axis and is also a surface which is orthogonal to the tire equator surface S1.

As shown in FIG. 1, the tire 1 according to the present embodiment is provided with a pair of bead portions (not shown), side wall portions (not shown) which extend to outer sides in the tire radial direction from the bead portions,, and a tread portion 2 which is connected to outer end portions of a pair of side wail portions in the tire radial direction and has an outer surface constructing a tread surface. The tire 1 is installed to a rim (not shown), and an internal portion of the tire 1 is pressurized by air.

The tread portion 2 is provided with a plurality of peripheral grooves 3 and 4 which extend along the tire peripheral direction D2, and a plurality of land portions 5 to 7 which are comparted into a plurality of peripheral grooves 3 and 4. In the present embodiment, four peripheral grooves 3 and 4 are provided, and five land portions 5 to 7 are provided. The numbers of the peripheral grooves 3 and 4 and the land portions 5 to 7 are not limited to the structures mentioned above.

The peripheral groove 3 arranged in the outermost side in the tire width direction D1 is called as a shoulder peripheral groove 3, and the peripheral groove 4 arranged closer to an inner side in the tire width direction D1 than the shoulder peripheral groove 3 is called as a center peripheral groove 4. Further, the land portion 5 arranged closer to an outer side in the tire width direction D1 than the shoulder peripheral groove 3 is called as the shoulder land portion 5, the land portion 6 arranged between the shoulder peripheral groove 3 and the center peripheral groove 4 is called as the mediate land portion 6, and the land portion 7 arranged between the center peripheral grooves 4 and 4 is called as the center land portion 7.

The land portions 5 to 7 are provided with a plurality of land grooves 8 and 9 which extend so as to intersect the tire peripheral direction D2. The land grooves 8 and 9 are provided with narrow grooves which are narrower than the peripheral grooves 3 and 4, and sipes which are narrower than the narrow grooves. For example, the narrow groove corresponds to a concave portion in which a width thereof is equal to or more than 1.0 mm, and the sipe corresponds to a concave portion in which a width thereof is less than 1.0 mm. Since a lot of land grooves 8 and 9 are provided as mentioned above, the snow steering stability performance of the tire 1 is excellent.

A description will be given of a structure of the land grooves 8 and 9 in relation to the land portions 5 to 7. A description will be given here of the mediate land portion 6 in the first width direction D11 side as an example with reference to FIG. 2.

First of all, as shown in FIG. 2, the land portion 6 is comparted into end areas A1 and A2 which are arranged in the outer side in the tire width direction D1, and a center area A3 which is arranged between the end areas A1 and A2. The end areas A1 and A2 and the center area A3 are comparted evenly (every one thirds) in the tire width direction D1. Further, the end area A1 in the first width direction D11 side is called as the first end area Al, and the end area A2 in the second width direction D12 side is called as the second end area A2.

The end areas A1 and A2 are comparted into center portions A11 and A21 which are arranged at the center in the tire width direction D1, inner portions A12 and A22 which are arranged in an inner side in the tire width direction D1 in the land portion 6, and outer portions A13 and A23 which are arranged in an outer side in the tire width direction D1 in the land portion 6. The center portions A11 and A21, the inner portions A12 and A22, and the outer portions A13 and A23 are comparted evenly (every one thirds) in the tire width direction D1.

Therefore, the center portions A11 and A21 correspond to an area which is equal to or more than one ninths and equal to or less than two ninths of the width W1 of the land portion 6 from end edges of the peripheral grooves 3 and 4. Further, the inner portions A12 and A22 corresponds to an area which goes beyond two ninths and is equal to or less than one thirds of the width W1 of the land portion 6 from the end edges of the peripheral grooves 3 and 4, and the outer portions A13 and A23 correspond to an area which is less than one ninths of the width W1 of the land portion 6 from the end edges of the peripheral grooves 3 and 4.

The first land groove 8 extends so as to have one bent portion 8a which is formed into a convex shape toward the first peripheral direction D21. Further, the second land groove 9 extends so as to have one bent portion 9a which is formed into a convex shape toward the second peripheral direction D22. Since the bent portion 8a of the first land groove 8 and the bent portion 9a of the second land groove 8 are formed into the convex shapes toward the different directions as mentioned above, it is possible to inhibit the rigidity of the land portion 6 from being small in relation to the force in the specific direction.

In the mediate land portion 6 in the first width direction D11 side, the first land groove 3 is a narrow groove and the second land groove 9 is a sipe. Further, in the present embodiment, “land grooves” 8 and 9 correspond to the groove respectively having one bent portions 8a and 9a, and the other grooves (the grooves having no bent portion and the grooves respectively having a plurality of bent portions) correspond simply to as “groove” 10 among the grooves provided in the land portions 5 to 7, and they are distinguished.

In the mediate land portion 6, among the land grooves 8 and 9 where the first land grooves 8 are adjacent in the tire peripheral direction D2, at least one of them forms the second land groove 9. For example, in the mediate land portion 6 in the first width direction D11 side, the land grooves 8 and 9 where the first land grooves 8 are adjacent in the tire peripheral direction D2 are both the second land grooves 9.

Further, in the mediate land portion 6, among the land grooves 8 and 9 where the second land grooves 9 are adjacent in the tire peripheral direction D2, at least one of them forms the first land groove 8. For example, in the mediate land portion 6 in the first width direction D11 side, the land grooves 8 and 9 where the second land grooves 8 are adjacent in the tire peripheral direction D2 are the first land groove 8 and the second land grooves 9.

The bent portion 8a of the first land groove 8 is formed into a curved shape fa curve line), and the first land groove 8 is provided in both sides of the bent portion 8a in the tire width direction Di with linear portions 8b and 8c which extend linearly. The bent portion 9a of the second land groove 9 is formed into a curved shape (a curve line), and the second land groove 9 is provided in both sides of the bent portion 9a in the tire width direction D1 with linear portions 9b and 9c which extend linearly.

Further, the bent portions 8a and 9a are arranged in the end areas A1 and A2 of the land portion 6. Specifically, the bent portion 8a of the first land groove 8 is arranged in the first end area A1 of the land portion 6, and the bent portion 9a of the second land groove 3 is arranged in the second end area A2 of the land portion 6. As mentioned above, since the bent portions 8a and 9a are arranged in both the end areas A1 and A2 of the land portion 6, rigidity in an outer side of the land portion 6 in the tire width direction D1 is enlarged, and it is possible to inhibit a rigidity difference from being generated in the tire width direction D1 of the land portion 6.

In the present embodiment, the bent portion 8a of the first land groove 8 is arranged in the center portion A1 of the first end area A1 in the land portion 6, and the bent portion 9a of the second land groove 9 is arranged in the center portion A21 of the second end area A2 in the land portion 6. More specifically, distances W2 and W3 from the end edges of the peripheral grooves 3 and 4 to the bent portions 8a and 9a of the land grooves 8 and 9 are equal to or more than one ninths and two ninths of the width W1 of the land portion 6.

Positions of the bent portions 8a and 9a in the tire width direction D1 are set to positions of folding points 8d and 9d. In the case that the bent portions 8a and 9a are formed into the curved shape, the folding points 8d and 9d are positions on the end edges in the inner side of the convex shape in the land grooves 8 and 9, and are also points closest to the ends in the tire peripheral direction D2 in the bent portions 8a and 9a. In the case that the bent portions 8a and Sa are formed into an inflected shape (a shape obtained by bending a straight line), the folding points 8d and 9d are points of inflected points (connected positions of two straight lines) on the end edge in the inner side of the convex shape of the land grooves 8 and 9.

For example, the bent portion 8a of the first land groove 8 is a point at the position on the end edge in the second peripheral direction D22 side in the first land groove 8 and at the position closest to the end in the first peripheral direction D21 in the bent portion 8a since the bent portion 8a is formed into the convex shape which is curved toward the first peripheral direction 21. Further, the bent portion 9a of the second land groove 9 is a point at the position on the end edge in the first peripheral direction D21 side in the second land groove 9 and at the position closest to the end in the second peripheral direction D22 in the bent portion 9a, since the bent portion 9a is formed into the convex shape which is curved toward the second peripheral direction 22.

It is preferable to structure such that the bent portions 8a and 9a of at least one half of the land grooves 8 and 9 are arranged in the end areas A1 and A2 of the land portions 6 and 7 in the tire width direction D1 such as the mediate land portion 6 according to the present embodiment. Further, it is preferable to structure such that the bent portions 8a and 9a of all the land grooves 8 and 3 are arranged in the end areas A1 and A2 of the land portions 6 and 7 in the tire width direction D1 such as the mediate land portion 6 according to the present embodiment.

In the meantime, since the bent portion 8a of the first land groove 8 is arranged in the first end area A1 in the first width direction D11 side, the rigidity of the first land groove 8 in the first width direction D11 side is enlarged. Accordingly, in the first land groove 8, the end portion of the linear portion 8c in the second width direction D12 side is away from the peripheral groove 4 in order to also enlarge the rigidity in the second width direction D12 side.

As a result, it is possible to inhibit the rigidity difference from being generated due to the first land groove 8, in both of the first width direction D11 and the second width direction D12 of the land portion 6. The end portion of the linear portion 8c of the first land groove 8 in the second width direction D12 side extends to the second end area A2 in the tire width direction D1. As a result, since the length of the edge of the first land groove 8 is accordingly elongated, it is possible to improve the snow steering stability. Further, in order to achieve a function (for example, a drainage function and an edge function) as the groove of the first land groove 8, the end portion of the linear portion 8b in the first width direction D11 side is connected to the peripheral groove 3.

In the same manner, since the bent portion Sa of the second land groove 9 is arranged in the second end area A2 in the second width direction D12 side, the rigidity of the second land groove 9 in the second width direction D12 side is enlarged. Accordingly, in the second land groove 9, the end portion of the linear portion 9c in the first width direction D11 side is away from the peripheral groove 3 in order to also enlarge the rigidity in the first width direction D11 side.

As a result, it is possible to inhibit the rigidity difference from being generated due to the second land groove 9, in both of the first width direction D11 and the second width direction D12 of the land portion 6. The end portion of the linear portion 9c of the second land groove 9 in the first width direction D11 side extends to the first end area A1 in the tire width direction D1. As a result, since the length of the edge of the second land groove 9 is accordingly elongated, it is possible to improve the snow steering stability. Further, in order to achieve the function (for example, the drainage function and the edge function) as the groove of the second land groove 9, the end portion of the linear portion 9b in the second width direction D12 side is connected to the peripheral groove 4.

Further a portion of the first land groove 8 is superposed on a portion of the second groove 9 in the tire peripheral direction D2. As a result, since edges of the land grooves 8 and 9 are arranged over the land portion 6 in the tire width direction D1, it is possible to improve the snow steering stability. It is preferable to structure such that the end portion in the side having the bent portions 8a and 9a of the land grooves 8 and 9 is connected to the peripheral grooves 4 and 3, and the end portion in the opposite side is away from, the peripheral grooves 3 and 4, in at least one half of land grooves 8 and 9 such as the mediate land portion 6 according to the present embodiment. Further, it is more preferable that all the land grooves 8 and 9 have the structure mentioned above, such as the mediate land portion 6 according to the present embodiment.

Further, in the first land groove 8, the rigidity tends to be smaller in the linear portion 8b in the first width direction D11 side which is connected to the peripheral groove 3, than in the linear portion 8c in the second width direction D12 side which is away from the peripheral groove 4. Accordingly, in the first land groove 8, an angle θ1 at which the linear portion 8b in the first width direction D11 side intersects the tire width direction D1 is smaller than an angle 82 at which the linear portion 8c in the second width direction D12 side intersects the tire width direction D1.

As mentioned above, since the angle θ1 at which the linear portion 8b in the first width direction D11 side intersects the tire width direction D1 becomes smaller, it is possible to inhibit the deformation of the first land groove 8 from being enlarged even in the case that the first land groove Sis exposed to the force in the tire width direction D1. Further, since the angle θ2 at which the linear portion 8c in the second width direction D12 side intersects the tire width direction D1 becomes larger, and the length of the first land groove 8 is accordingly elongated, it is possible to improve the snow steering stability performance.

In the same manner, in the second land groove 3, the rigidity tends to be smaller in the linear portion 9b in the second width direction D12 side which is connected to the peripheral groove 4, than in the linear portion 9c in the first width direction D11 side which is away from the peripheral groove 3. Accordingly, in the second land groove 9, an angle θ3 at which the linear portion 3b in the second width direction D12 side intersects the tire width direction D1 is smaller than an angle θ4 at which the linear portion 9c in the first width direction D11 side intersects the tire width direction D1.

As mentioned above, since the angle θ3 at which the linear portion 9b in the second width direction D12 side intersects the tire width direction D1 becomes smaller, it is possible to inhibit the deformation of the second land groove 9 from being enlarged even in the case that the second land groove 9 is exposed to the force in the tire width direction D1. Further, since the angle θ4 at which the linear portion 9c in the first width direction D11 side intersects the tire width direction D1 becomes larger, and the length of the second land groove 8 is accordingly elongated, it is possible to improve the snow steering stability performance.

The angles θ1 to θ4 at which the one side or the other side of the bent portions 8a and 9a of the land grooves 8 and 9 intersects the tire width direction D1 correspond to angles at which the end edges in the side having the folding points 8d and 9d of the land grooves 8 and 9 intersect the tire width direction D1. Further, in the case that the bent portions 8a and 9a are formed into the curved shape and any linear portions 8b, 8c, 9b and 9c do not exist in the one side or the other side of the bent portions 8a and 3a, the angles θ1 to θ4 correspond to angles at which tangent lines at the end points of the bent portions 8a and 9a intersect the tire width direction D1.

The angles θ1 to θ4 are preferable equal to or more than 10 degree in order to enlarge the rigidity of the land grooves 8 and 9 by the bent portions 8a and Sa, and are more preferably equal to or more than 15 degree. Further, the angles θ1 to θ4 are preferably equal to or less than 45 degree in such a manner as to prevent the land grooves 8 and 9 from being excessively deformed when the force in the tire width direction D1 is applied, and are more preferably equal to or less than 40 degree.

It is preferable to structure such that the angles θ1 and θ3 at which the side connected to the peripheral grooves 3 and 4 intersects the tire width direction D1 are smaller than the angles θ2 and θ4 at which the side being away from the peripheral grooves 4 and 3 intersects the tire width direction D1, in relation to the bent portions 8a and 9a of the land grooves 8 and 9, in at least one half of the land grooves 8 and 9, such as the mediate land portion 6 according to the present embodiment. Further, it is more preferable that the above structure is applied to all the land grooves 8 and 9 such as the mediate land portion 6 according to the present embodiment.

Turning back to FIG. 1, in the present embodiment, the land grooves 8 and 9 are provided with the bent portions 8a and 9a which are formed into the convex shape in the same directions D21 and D22, the land grooves 8 and 5 being connected to the center peripheral groove 4 and being arranged in both sides of the peripheral groove 4. For example, the land grooves 9 connected to the center peripheral groove 4 in the first width direction D11 side and arranged in both sides of the peripheral groove 4 are all the second land grooves 9, and the land grooves 8 connected to the center peripheral groove 4 in the second width direction D12 side and arranged in both sides of the peripheral groove 4 are all the first land groove 8.

As described above, the pneumatic tire 1 of the embodiment include: a tread portion 2 having a plurality of grooves 3 and 4 which extend along a tire peripheral direction D2, and a plurality of land portions 5 to 7 which are comparted in the plurality of peripheral grooves 3 and 4, wherein at least one the land portion 6 (7) comprises: at least one first land groove 8 which extends so as to have one bent portion 8a formed into a convex shape toward one D21 side in the tire peripheral direction D2; and at least one second land groove 8 which extends so as to have one bent portion Sa formed into a convex shape toward the other D22 side in the tire peripheral direction D2.

According to the structure, at least one land portions 6 and 7 are provided with at least one first land groove 8 and second land groove 9 extending in such a manner as to respectively have one bent portions 8a and 9a. Further, the bent portion 8a of the first land groove 8 is formed into the convex shape toward the one D21 side of the tire peripheral direction D2, and the bent portion 9a of the second land groove 9 is formed into the convex shape toward the other side D22 side of the tire peripheral direction D2.

As a result, since the bent portion 8a of the first land groove 8 and the bent portion 9a of the second land groove 9 are formed into the convex shapes toward the different directions D21 and D22, it is possible to inhibit the rigidity of the land portions 6 and 7 from being smaller in relation to the force in the specific direction. Therefore, since it is possible to inhibit the deformation of the land portions 6 and 7 from being enlarged, for example, even in the case that the land portions 6 and 7 are exposed to the forces in the different directions caused by the different turning directions, it is possible to improve the dry turning performance of the tire 1.

In the pneumatic tire 1 of the embodiment, the bent portions 8a and 9a of the land grooves 8 and 9 are arranged in end areas A1 and A2 of the land portion 6 in a tire width direction D1.

According to the structure mentioned above, since the bent portions 8a and 9a of the land grooves 8 and 9 are arranged in the end areas A1 and A2 of the land portion 6 in the tire width direction D1, the rigidity of the end areas A1 and A2 of the land portion 6 in the tire width direction D1 is enlarged. As a result, it is possible to further improve the dry turning performance of the tire 1.

In the pneumatic tire 1 of the embodiment, the bent portion 8a of at least one the land groove 8 is arranged in the end area A1 in one D11 side of the land portion 6 in the tire width direction. D1, and the bent portion 9a of at least one the land groove 9 is arranged in the end area A2 in the other D12 side of the land portion 6 in the tire width direction D1.

According to the structure mentioned above, the bent portions 8a and 9a of the land grooves 8 and 9 are arranged in the both end areas A1 and A2 of the land portion 6 in the tire width direction D1. As a result, the rigidity of the end areas A1 and A2 of the land portion 6 in the tire width direction D1 is enlarged, and it is possible to inhibit the rigidity difference from being generated in the tire width direction D1 of the land portion 6. Therefore, it is possible to improve the dry turning performance of the tire 1, and it is possible to improve the dry braking performance.

In the pneumatic tire 1 of the embodiment, the bent portion 8a of the first land groove 8 is arranged in one D11 side of the land portion 6 in the tire width direction D1, end portion in the one D11 side of the first land groove 8 in the tire width direction D1 is connected to the peripheral groove 3, and end portion in the other D12 side of the first land groove 8 in the tire width direction D1 is away from the peripheral groove 4.

According to the structure mentioned above, since the bent portion 8a of the first land groove 8 is arranged in the one D11 side of the land portion 6 in the tire width direction D1, the rigidity of the one D11 side of the first land groove 8 in the tire width direction D1 is enlarged. Further, since the end portion in the other D12 side of the first land groove 8 in the tire width direction D1 is away from the peripheral groove 4, the rigidity of the other D12 side of the first land groove 8 in the tire width direction D1 can be enlarged.

As a result, it is possible to inhibit the rigidity difference from being generated in the one D11 side and the other D12 side of the land portion 6 in the tire width direction D1. Therefore, it is possible to further improve the dry turning performance of the tire 1, and it is also possible to improve the dry braking performance of the tire 1. Further, since the end portion in the one D11 side of the first land groove 8 in the tire width direction D1 is connected to the peripheral groove 3, the function (the drainage function and the edge function) as the groove can be achieved.

In the pneumatic: tire 1 of the embodiment, angle θ1 at which the one D11 side of the bent portion 8a of the first land groove 8 intersects the tire width direction D1 is smaller than angle θ2 at which the other D12 side of the bent portion 8a of the first land groove 8 intersects the tire width direction D1.

According to the structure mentioned above, in relation to the matter that the rigidity in the one D11 side of the first land groove 8 connected to the peripheral groove 3 tends to be small, the angle θ1 at which the one D11 side of the bent portion 8a of the first land groove 8 intersects the tire width direction D1 is made smaller than the angle θ2 at which the other D12 side of the bent portion 8a of the first land groove 8 intersects the tire width direction D1.

As a result, it is possible to inhibit the rigidity in the one D11 side of the bent portion 8a of the first land groove 8 from becoming too small. Therefore, even in the case that the land portion 6 is exposed to the force in the tire width direction D1, it is possible to inhibit the deformation in the one D11 side of the bent portion 8a of the first land groove 8 from being enlarged.

The pneumatic tire 1 is not limited to the configuration of the embodiment described above, and the effects are not limited to those described above. It goes without saying that the pneumatic tire 1 can be variously modified without departing front the scope of the subject matter of the present invention. For example, the constituents, methods, and the like of various modified examples described below may be arbitrarily selected and employed as the constituents, methods, and the like of the embodiments described above, as a matter of course.

The pneumatic tire 1 according to the embodiment mentioned above is structured such that all the grooves provided in the predetermined land portion 6 are the land grooves 8 and 9 respectively having one bent portions 8a and 9a. However, the pneumatic tire 1 is not limited to the structure mentioned above. For example, the pneumatic tire 1 may be structured as long as at least one groove is the first land groove 8 having one bent portion 8a, and at least one groove is the second land groove 9 having one bent portions 8a and 9a, in the grooves provided in the predetermined land portions 5 to 7.

It is preferable to structure such that one half or more number of grooves are the land grooves 8 and 9 respectively having one bent portions 3a and 9a in the grooves provided in the predetermined land portions 6 and 7, such as the mediate land portion 6 and the center land portion 7 according to the embodiment mentioned above. Further, it is further preferable to structure such that all the grooves are the land grooves 8 and 9 respectively having one bent portions 3a and 9a in the grooves provided in the predetermined land portion 6, such as the mediate land portion 6 according to the embodiment mentioned above.

Further, the pneumatic tire 1 according to the embodiment mentioned above is structured such that the mediate land portion 6 and the center land portion 7 are provided with the first land groove 8 and the second land groove 9. However, the pneumatic tire 1 is not limited to the structure mentioned above. For example, the pneumatic tire may be structured such that at least one land portion is provided with the first land groove 8 and the second land groove 9.

It is preferable to structure such that at least the land portion 6 arranged between the shoulder peripheral groove 3 and the center peripheral groove 4 is provided with the first land groove 8 and the second land groove 9, such as the pneumatic tire 1 according to the embodiment mentioned above. Further, it is further preferable to structure such that at least the land portions 6 and 7 arranged between the peripheral grooves 3 and 4 are provided with the first land groove 8 and the second land groove 9, such as the pneumatic tire 1 according to the embodiment mentioned above.

Further, the pneumatic tire 1 according to the embodiment mentioned above is structured such that the bent portions 8a and 9a of the land grooves 8 and 9 are arranged in the end areas A1 and A2 of the land portion 6 in the tire width direction D1. However, the pneumatic tire 1 is not limited to the structure mentioned above. For example, the pneumatic tire may be structured such that the bent portions 8a and 9a of the land grooves 8 and 9 are arranged in the center area A3 of the land portion 7 in the tire width direction D1, such as the center land portion 7 according to the embodiment mentioned above.

Further, the pneumatic tire 1 according to the embodiment mentioned above is structured such that the bent portions 8a and 9a of the land grooves 8 and 9 are arranged in both the end areas A1 and A2 of the land portion 6 in the tire width direction D1. However, the pneumatic tire 1 is not limited to the structure mentioned above. For example, the pneumatic tire may be structured such that the bent portions 8a and 9a of the land grooves 8 and 9 are arranged only in one end area A1 (A2) of the land portion 6 in the tire width direction D1.

Further, the pneumatic tire 1 according to the embodiment mentioned above is structured such that the end portion in the side having the bent portions 8a and 9a of the land grooves 8 and 9 is connected to the peripheral grooves 4 and 3, and the end portion in the opposite side thereto is away from the peripheral grooves 3 and 4. However, the pneumatic tire 1 is not limited to the structure mentioned above.

For example, the pneumatic tire may be structured such that the end portion in the side having the bent portions 8a and 9a of the land grooves 8 and 9 is away from the peripheral grooves 4 and 3, and the end portion in the opposite side thereto is connected to the peripheral grooves 3 and 4. Further, for example, the pneumatic: tire may be structured such that the end portions in both sides of the land grooves 8 and 9 are connected to the peripheral grooves 3 and 4. Further, for example, the pneumatic tire may be structured such that the end portions in both sides of the land grooves 8 and 9 are away from the peripheral grooves 3 and 4.

Further, the pneumatic tire 1 according to the embodiment mentioned above is structured such that the angles θ1 and θ3 at which the side connected to the peripheral grooves 3 and 4 intersects the tire width direction D1 are smaller than the angles θ2 and θ4 at which the side being away from the peripheral grooves 4 and 3 intersects the tire width direction D1, in relation to the bent portions 8a and 9a of the land grooves 8 and 9. However, the pneumatic tire 1 is not limited to the structure mentioned above.

For example, the pneumatic tire may be structured such that the angles θ1 and θ3 at which the side connected to the peripheral grooves 3 and 4 intersects the tire width direction D1 are larger than the angles θ2 and θ4 at which the side being away from the peripheral grooves 4 and 3 intersects the tire width direction D1. Further, for example, the pneumatic tire may be structured such that the angles θ1 and θ3 at which the side connected to the peripheral grooves 3 and 4 intersects the tire width direction D1 are the same as the angles θ2 and θ4 at which the side being away from the peripheral grooves 4 and 3 intersects the tire width direction D1.

### EXAMPLES

In order to specifically show the structure and the effect, of the tire 1, a description will be given below of examples of the tire 1 and a comparative example thereof with reference to FIGS. 3 to 5.

### <Dry Turning Performance (Cornering Power)>

A cornering power was determined by using a drum tester having a diameter of 2500 mm, measuring a cornering force generated in a tire under an internal pressure of 200 kPa and a load of 4.2 kN, and dividing a difference of the cornering force values at a slip angle ±1 degree by a difference of the angles, in relation to each of tires having a size of 195/65R15. An evaluation is made by an index number on the assumption that the result of a comparative example 1 is 100, and the greater the numerical value is, the greater the cornering power is, thereby indicating an excellent dry turning performance.

<Dry Braking Performance>

A braking distance was measured in the case that each of the tires having the size of 1S5/65R15 is installed to the vehicle and an ABS is activated from a state in which the vehicle is travels on a dry road surface (an asphalt paved road surface) at a speed of 100 km/h, and an inverted number of the measured value was calculated. An evaluation is made by an index number on the assumption that the result of the comparative example 1 is 100, and the result indicates that the greater the numerical value is, the more excellent the dry braking performance is.

<Snow Steering Stability Performances>

Each of the tires having the size of 195/65R15 was installed to the vehicle, and the vehicle was traveled on the snow road surface while accelerating, braking, turning and changing lanes. Further, a steering stability performance was evaluated according to a feeling test by a driver. An evaluation is made by an index number on the assumption that the result of the comparative example 1 is 100, and the result indicates that the greater the index number is, the more excellent the snow steering stability performance is.

### Example 1

An example 1 is the tire 1 according to the embodiment in FIGS. 1 and 2. Specifically, since the distances W2 and W3 from the end edges of the peripheral grooves 3 and 4 to the bent portions 8a and 9a of the land grooves 8 and 9 are two elevenths (equal to or more than one ninth and equal to or less than two ninths) of the width W1 of the land portion 6, in each of the mediate land portions 6 of the embodiment 1, the bent portions 8a and 9a are arranged in the center portions A11 and A21 of the end areas A1 and A2.

### Example 2

An example 2 is a tire in which the positions of the bent portions 8a and 9a are changed in each of the mediate land portions 6 in relation to the tire according to the example 1. Specifically, in each of the mediate land portions 6 in the example 2, the distances W2 and W3 from the end edges of the peripheral grooves 3 and 4 to the bent portions 8a and 9a of the land grooves 8 and 9 are seven twenty seconds (goes beyond two ninth and equal to or less than one thirds) of the width W1 of the land portion 6. As a result, the bent portions 8a and 9a are arranged in the inner portions A12 and A22 of the end areas A1 and A2.

### Example 3

An example 3 is a tire in which the positions of the bent portions 8a and 9a are changed in each of the mediate land portions 6 in relation to the tire according to the example 1. Specifically, in each of the mediate land portions 6 in the example 3, the distances W2 and W3 from the end edges of the peripheral grooves 3 and 4 to the bent portions 8a and 9a of the land grooves 8 and 9 are one elevenths (goes beyond 0 and less than one ninths) of the width W1 of the land portion 6. As a result, the bent portions Sa and Sa are arranged in the outer portions A13 and A23 of the end areas A1 and A2.

### Example 4

An example 4 is a tire in which the positions of the bent portions 8a and 9a are changed in each of the mediate land portions 6 in relation to the tire according to the example 1. Specifically, in each of the mediate land portions 6 in the example 4, the distances W2 and W3 from the end edges of the peripheral grooves 3 and 4 to the bent portions 8a and 9a of the land grooves 8 and 9 are one half of the width W1 of the land portion 6, as shown in FIG. 3. As a result, the bent portions 8a and 9a are arranged at the center of the land portion 6 and in the center area A3.

### Comparative Example 1

A comparative example 1 is a tire in which the structure is changed in such a manner as to be provided with only the second land groove 9 in each of the mediate land portions 6, in relation to the tire according to the example 4. More specifically, each of the mediate land portions 6 according to the comparative example 1, the bent portions 9a are arranged at the center of the land portion 6 and in the center area A3, and are all formed into a convex shape toward the second peripheral direction D22, as shown in FIG. 4.

<Results of Evaluation>

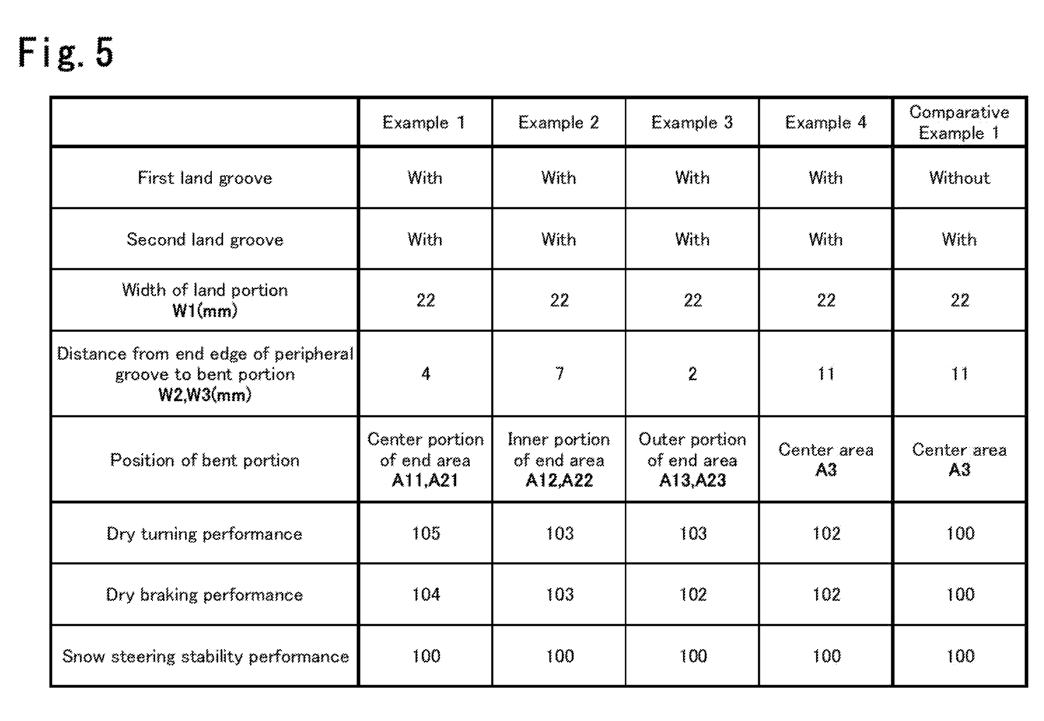

As shown in FIG. 5, the examples 1 to 4 can improve the dry turning performance while maintaining the snow steering stability performance, in comparison with the comparative example 1. Since the land portion 6 is provided with both of the first land groove 8 and the second land groove 9 as mentioned above, it is possible to improve the dry turning performance while maintaining the snow steering stability performance.

Further, a description will be given below of a more preferable example of the tire 1.

First of all, the examples 1 to 3 can improve the dry turning performance and the dry braking performance in comparison with the example 4. As mentioned above, in order to improve the dry turning performance and the dry braking performance, the bent portions 8a and 9a of the land grooves 8 and 9 are preferably structured such as to be arranged in the end areas A1 and A2 of the land portion 6 in the tire width direction D1.

Further, the example 1 can improve the dry turning performance and the dry braking performance in comparison with the examples 2 and 3. As mentioned above, in order to further improve the dry turning performance and the dry braking performance, the bent portions 8a and 9a of the land grooves 8 and 9 are preferably structured such as to be arranged in the center portions A11 and A21 of the end areas A1 and A2 of the land portion 6 in the tire width direction D1. More specifically, the distances W2 and W3 from the end edges of the peripheral grooves 3 and 4 to the bent portions 8a and 9a of the land grooves 8 and 9 are preferably structured such as to be equal to or more than one ninths and equal to or less than two ninths of the width W1 of the land portion 6.

What is claimed is:

1. A pneumatic tire comprising:
a tread portion having a plurality of grooves which extend along a tire peripheral direction, and a plurality of land portions which are comparted in the plurality of peripheral grooves,
wherein at least one the land portion comprises:
at least one first land groove which extends so as to have one bent portion formed into a convex shape toward one side in the tire peripheral direction; and
at least one second land groove which extends so as to have one bent portion formed into a convex shape toward the other side in the tire peripheral direction.

2. The pneumatic tire according to claim 1, wherein the bent portion of the first land groove is arranged in a first end area in one side of the land portion in a tire width direction,
wherein end portion in the one side of the first land groove in the tire width direction is connected to the peripheral grooves, and
wherein end portion in the other side of the first land groove in the tire width direction is away from the peripheral groove and is arranged in a second end area in the other side of the land portion in the tire width direction.

3. The pneumatic tire according to claim 2, wherein the bent portion of the second land groove is arranged in the second end area,
wherein end portion in the other side of the second land groove in the tire width direction is connected to the peripheral grooves, and
wherein end portion in the one side of the second land groove in the tire width direction is away from the peripheral groove and is arranged in the first end area.

4. The pneumatic tire according to claim 1, wherein end portion in one side of the first land groove in a tire width direction is connected to the peripheral grooves, and end portion in the other side of the first land groove in the tire width direction is away from the peripheral groove,
wherein end portion in the other side of the second land groove in the tire width direction is connected to the peripheral grooves, and end portion in the one side of the second land groove in the tire width direction is away from the peripheral groove, and
a portion of the first land groove is superposed on a portion of the second groove in the tire peripheral direction.

5. The pneumatic tire according to claim 4, wherein the bent portion of the first land groove is arranged in a first end area in the one side of the land portion in the tire width direction, and
wherein the bent portion of the second land groove is arranged in a second end area in the other side of the land portion in the tire width direction.

6. The pneumatic tire according to claim 1, wherein the bent portion of the first land groove is arranged in a first end area in one side of the land portion in a tire width direction,
wherein end portion in the one side of the first land groove in the tire width direction is connected to the peripheral grooves,
wherein end portion in the other side of the first land groove in the tire width direction is away from the peripheral groove, and
wherein angles at which the one side of the bent portion of the first land groove intersects the tire width direction is smaller than angle at which the other side of the bent portion of the first land groove intersects the tire width direction.

7. The pneumatic tire according to claim 6, wherein the bent portion of the second land groove is arranged in a second end area in the other side of the land portion in the tire width direction,
wherein end portion in the other side of the second land groove in the tire width direction is connected to the peripheral grooves,
wherein end portion in the one side of the second land groove in the tire width direction is away from the peripheral groove, and
wherein angles at which the other side of the bent portion of the second land groove intersects the tire width direction is smaller than angle at which the one side of the bent portion of the second land groove intersects the tire width direction.

8. The pneumatic tire according to claim 2, wherein the bent portion of the first land groove is arranged in center portion of the first end area.

9. The pneumatic tire according to claim 3, wherein the bent portion of the second land groove is arranged in center portion of the second end area.

10. The pneumatic tire according to claim 1, wherein at least one of the land grooves where the first land grooves are adjacent in the tire peripheral direction is the second land groove, and
wherein at least one of the land grooves where the second land grooves are adjacent in the tire peripheral direction (D2) is the first land groove.
